(19) United States
(12) Patent Application Publication
(10) Pub. No.: US 2011/0277693 A1
(43) Pub. Date: Nov. 17, 2011

(54) Systems and Methods to Control the Incursion of Fish into Seachests

(76) Inventor: John Parkin, Vancouver, WA (US)

(21) Appl. No.: 12/917,274

(22) Filed: Dec. 15, 2010

Related U.S. Application Data
(60) Provisional application No. 61/334,515, filed on May 13, 2010.

(51) Int. Cl. A01K 61/00; A01K 79/02

(52) U.S. Cl. 119/220; 43/17.1

(57) ABSTRACT

Described herein is an apparatus for the entrainment of fish from seachests having an anode, a cathode, a support structure for the anode and cathode proximate to the hull of a ship, such that when an electric current passes from the anode to the cathode, fish are entrained from entering a seachest.

### RELATED APPLICATIONS

This application claims the benefit of U.S. Provisional Application No. 61/334,515; filed May 13, 2010, the contents herein incorporated into this application by reference.

### BACKGROUND

The present inventive subject matter relates to the systems and methods to prevent fish from entering seachests in general and seachests for liquid natural gas (LNG) tankers in particular.

The effect of electric currents on fish are well known in the prior art and as described in the prior art of electrofishing. Electrofishing involves the use of electric currents to attract and/or repel fish with the intent of creating aquatic barriers, sample fish populations, and/or to increase collection yields.

It has been established that relatively small potentials impressed across the body of a fish will result in a flight reaction in the fish (e.g. the fish will swim away from the electric field). An increase in the electric potential impressed across the fish results in a physiological response where the alignment of the fish with the electric current, or electrotaxis. Still larger potentials may result in unconciousness or complete euthanasia of the fish.

Electrofishing barriers has traditionally been used in freshwater lakes and streams and are the subject of U.S. Pat. Nos. 5,445,111; 5,327,854; 4,750,451; 4,672,967; 4,713,315; 5,111,379; 5,233,782; 5,270,912; 5,305,711; 5,311,694; 5,327,668; 5,341,764; 5,551,377; and 6,978,734 which are incorporated herein by reference. Also, electrofishing has been the used to stimulate yields of fishing in conjunction with the use of trawl nets as described in U.S. Pat. Nos. 3,110,978 and 4,417,301 which are also incorporated herein by reference.

Systems for controlling electricity in aquatic environments have been described in U.S. Pat. No. 5,460,123 which is incorporated herein by reference.

Therefore in the prior art, a considerable body of work is associated with the electrification of large bodies of water to impress electric fields across larger fish, such as salmon or trout. Furthermore, the use of electricity to entrain and/or repel fish is not limited to salmon or trout, but, may be used on almost all aquatic species.

Sea chests are portals located on ships that are used as intake chambers to drawing in water. Seachests are further described in U.S. Pat. No. 4,767,367 and U.S. Patent Application # 20080295758. When seachests are in operation, the drawing in of water results in fish and other aquatic species being drawn into the seachest with the flow of the water. This often results in the injury and/or death of the fish. Furthermore, screens that are placed on the screens or the intake chamber that filter debris must be cleaned on regular intervals.

Therefore, what is desired is an apparatus to repel fish so before they drawn into seachests. It is also desired that this apparatus be mobile so that they be placed close to the ship when the seachests are in use.

### SUMMARY

The present inventive subject matter overcomes problems in the prior art by providing an apparatus for the entrainment of fish from seachests having a floatable platform on a body of water; the floatable platform having a top part and a bottom part, a front part, and a back part and an operating location on the top part of the floatable platform, the floatable platform being proximately placed relative to a hull of a ship; an adjustable electrode system, the adjustable electrode system being vertically adjustable relative to the bottom part of the floatable platform and horizontally adjustable relative to the hull of the ship; a pulstator, said pulsator being electrically connected to the adjustable electrode system; so that when the pulsator is activated an electrical field is formed in the body of water proximate to the hull of the ship, fish are entrained from entering a seachest located in the hull of the ship. The apparatus for the entrainment of fish from seachests further having an adjustable electrode system with a multiplicity of anodes and a multiplicity of cathodes, the electric field being induced in the water; and further setting the pulsator to induce an electrical field between the anodes and the cathodes from 0.5 volts per inch to 1.5 volts per inch in the body of water proximate to the seachest located in the hull of the ship and further having the apparatus for the entrainment of fish from seachests so that the adjustable electrode system further has a multiplicity of cathodes vertically spaced in a vertically interleaved manner, and the multiplicity of anodes vertically spaced in a vertically interleaved manner, so that the electrical fields may be positionally modified along the vertical axis, and further having an apparatus for the entrainment of fish from seachests with a setting of the pulsator to induce an electrical field that is pulsed from a 1% to a 50% duty cycle; so that the top part and a bottom part, the bottom part of the adjustable electrode system being mechanically connected to the hull of the ship.

The present inventive subject matter is an apparatus for the entrainment of fish from seachests having a hanging platform off the side of the ship above a body of water; the hanging platform having a top part and a bottom part, a front part, and a back part and an operating location on the top part of the hanging platform, the hanging platform further being proximately alongside the hull of a ship; an adjustable electrode system, the adjustable electrode system being vertically adjustable relative to the bottom part of the hanging platform and horizontally adjustable relative to the hull of the ship; a pulstator, said pulsator being electrically connected to the adjustable electrode system and mechanically placed on the top part of the hanging platform; so that when the pulsator is activated an electrical field is formed in the body of water proximate to the hull of the ship, and fish are entrained from entering a seachest located in the hull of the ship. The inventive subject matter further having an adjustable electrode system further comprises a multiplicity of anodes and a multiplicity of cathodes, the electric field being induced in the water; said adjustable electrode system setting the pulsator to induce an electrical field between the anodes and the cathodes from 0.5 volts per inch to 1.5 volts per inch in the body of water proximate to the seachest located in the hull of the ship; further setting the pulsator to induce an electrical field that is pulsed from a 1% to a 50% duty cycle; further having a multiplicity of cathodes vertically spaced in a vertically interleaved manner, and the multiplicity of anodes vertically spaced in a vertically interleaved manner, so that the electrical fields may be positionally modified along the vertical axis.

The present inventive subject matter describes a method for entrainment of fish proximate to seachests, comprising the steps of placing a multiplicity of anodes and cathodes relative to a seachest; creating an electrical field between the anodes and cathodes; the electrical field created by a pulsator; so that fish proximate to the anode and cathode are entrained by the electrical field. The method further comprises the entrainment of fish proximate to seachests having the steps of setting the pulsator to create a field ranging from 0.5 volts per inch to 1.5 volts per inch and the steps of setting the pulsator to create a field with a duty cycle from 1% to 50%.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 is an embodiment of the fish entrainment system with a vertical electrode system.

FIG. 2 is an embodiment of a fish entrainment system with horizontal electrodes.

FIG. 3 is an embodiment of a fish entrainment system with the system that rests against the side of the hull of a boat.

FIG. 4 is an embodiment of a fish entrainment system with a suspended anode/cathode design.

FIG. 5 is an embodiment of a fish entrainment system with a support bracket extending from the seachest.

FIG. 6 is an embodiment of a fish entrainment system with a dual wrapped mat design.

### LIST OF REFERENCE CHARACTERS

110—Platform
120—Fish
130—Seachest
140—Vertical Electrode Positioner
145—Vertical Electrode Support
150—Anode
160—Cathode
170—Horizontal Positioner
180—Hull
310—Hull Platform
320—Hull Support
410—Platform
420—Positioning
510—Support Bracket
620—Ballast
630—Ballast Anchor
640—Ballast Support

### DETAILED DESCRIPTION

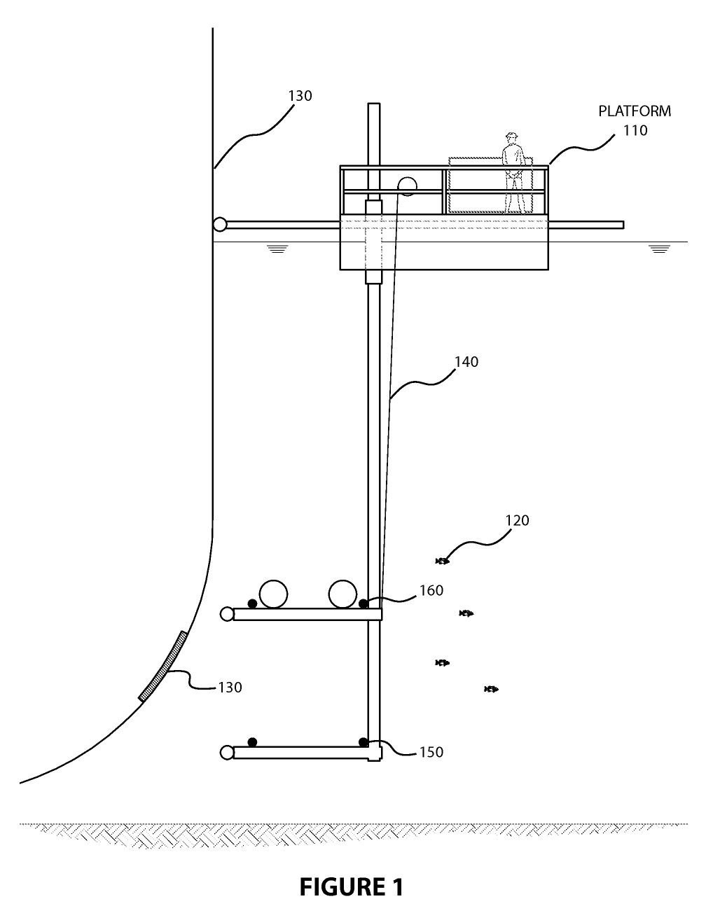

Representative embodiments according to the inventive subject matter are shown in FIGS. 1-6, wherein similar features share common reference numerals.

Now referring to FIG. 1 which is an embodiment of the fish entrainment system with a vertical electrode system. The ship contains a seachest 130 which draws water and fish 120 that are adjacent to the seachest 130.

The platform 110 is floated on the surface of the water adjacent to a hull 180. The electrical anodes 150 and cathodes 160 are supported by vertical electrode support 145 positioned relative to the seachest 130 by a vertical electrode positioner 140. The platform 110 may be positioner relative the hull of the ship with a horizontal positioner. This embodiment allows for ease of positioning the anode and cathode relative to the ships hull.

In operation it is anticipated that the operator on the platform 110 moves the electrical anodes 150 and cathodes 160 into an optimal location relative to the hull 180 so the generated electric field allows for the deterrance of fish 120 due to the physiological response of the fish.

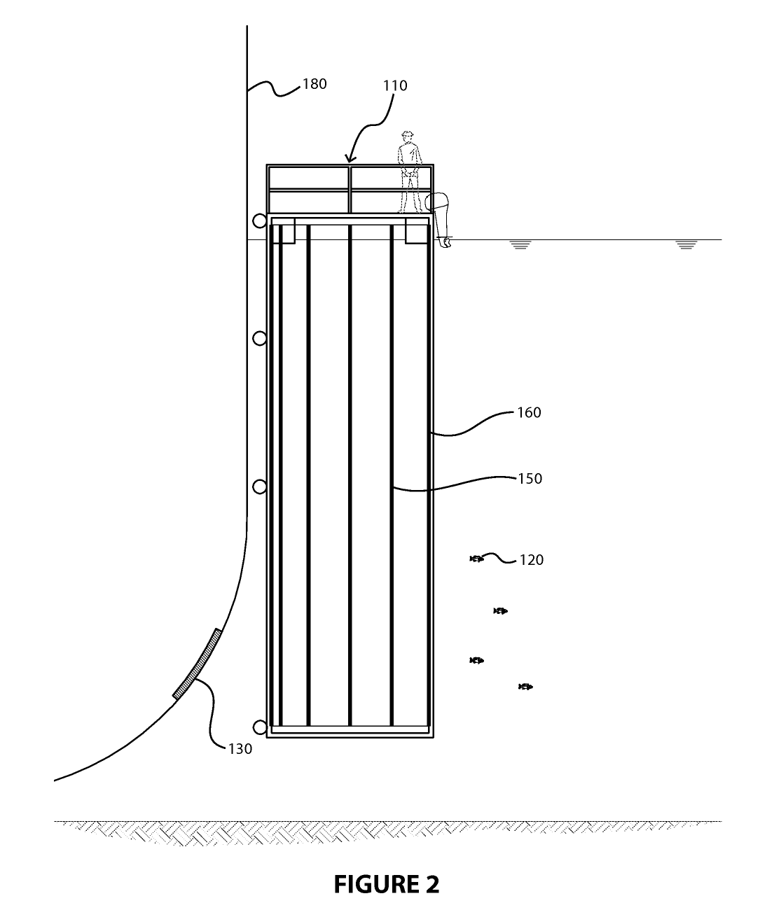

Now referring to FIG. 2 which depicts an embodiment of a fish entrainment system with horizontal electrodes. This system has a platform 110 with anodes 150 and cathodes 160 positioned horizontally and parallel to the hull 180. The platform 180 is moved into a locate adjacent to the hull. Although illustrated as extending from near to the surface of the water to the bottom of the seachest, the actual length of the electrodes may be reduced to reduce fabrication and installation costs.

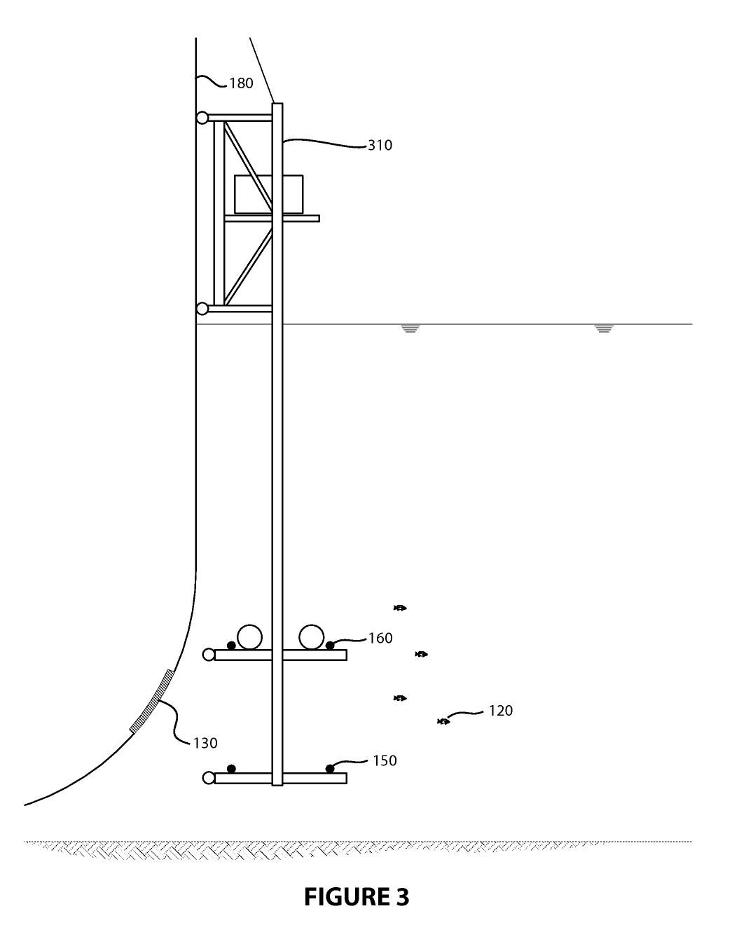

Now referring to FIG. 3 is another embodiment of a fish entrainment system with the hull platform 310 that is configured to drop from the side of the hull 180 of the ship using a hull support 320. One advantage of this embodiment is that the fish entrainment system may be deployed over the hull 180 of the ship rather than using a separate floating platform. Beneath the water, the anode 150 and cathode 160 may be manuveured close to the sea chest 130 to optimize the entrainment of fish. The hull support 320 may be fabricated from a flexible material, such as, a rope or a cable; or the hull support 320 may be fabricated from a rigid piece of material, such as, a piece of metal or rebar.

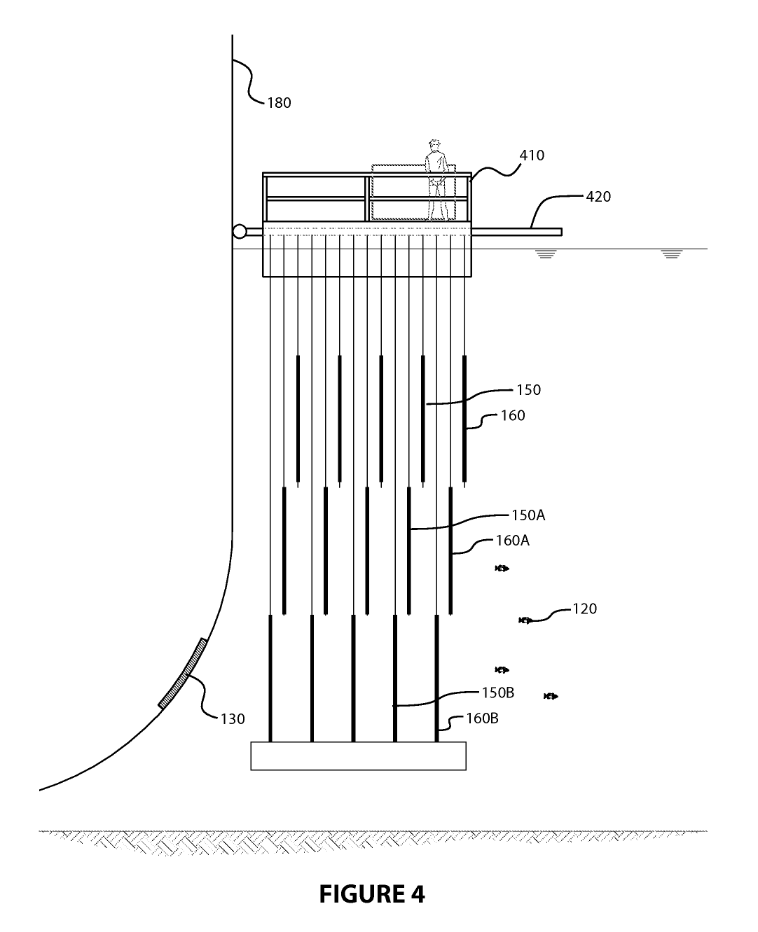

Now referring to FIG. 4 which depicts an alternate embodiment of a fish entrainment system with a suspended and interleaved anode/cathode design. The platform 110 which has a horizontal positioner 170 for adjusting the platform 110 relative to the hull 180 of the ship. The anodes 150, 150a,150b and cathodes 160, 160a,160b are interleaved to provide greater adjustability of the electrical fields.

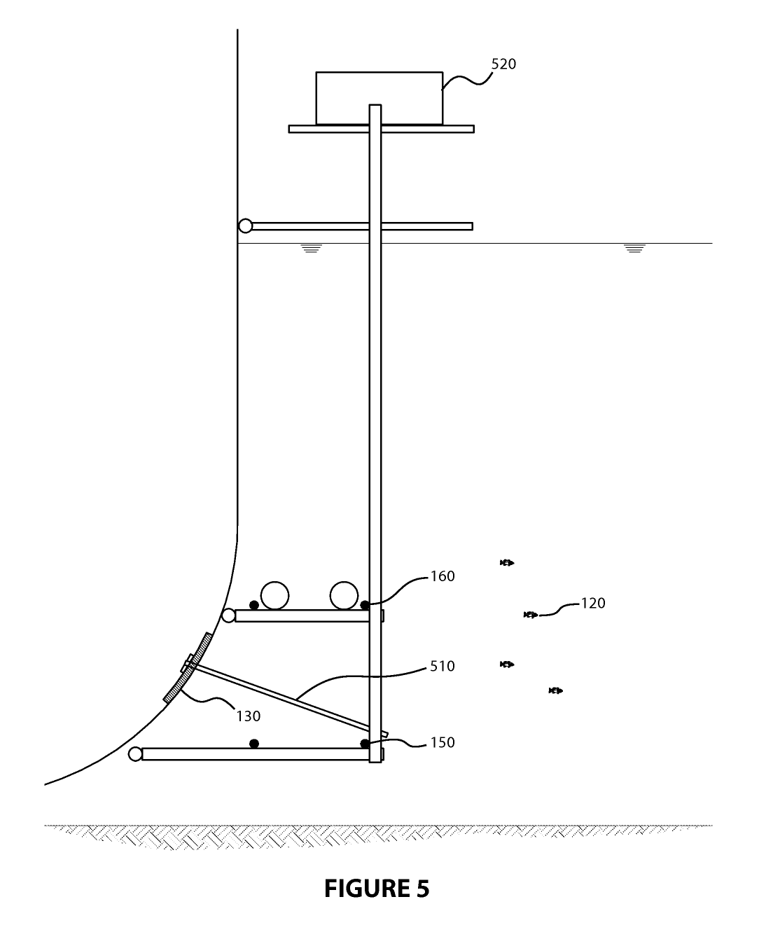

Now referring to FIG. 5 which depicts an alternate embodiment of a fish entrainment system with a support bracket 510 extending from the sea chest 130 130. The support bracket 510 allows the anode 150 and cathode 160 to be positioned relative to the sea chest 130. This support bracket 510 is used to stabilize the platform relative to the opening of the sea chest 130.

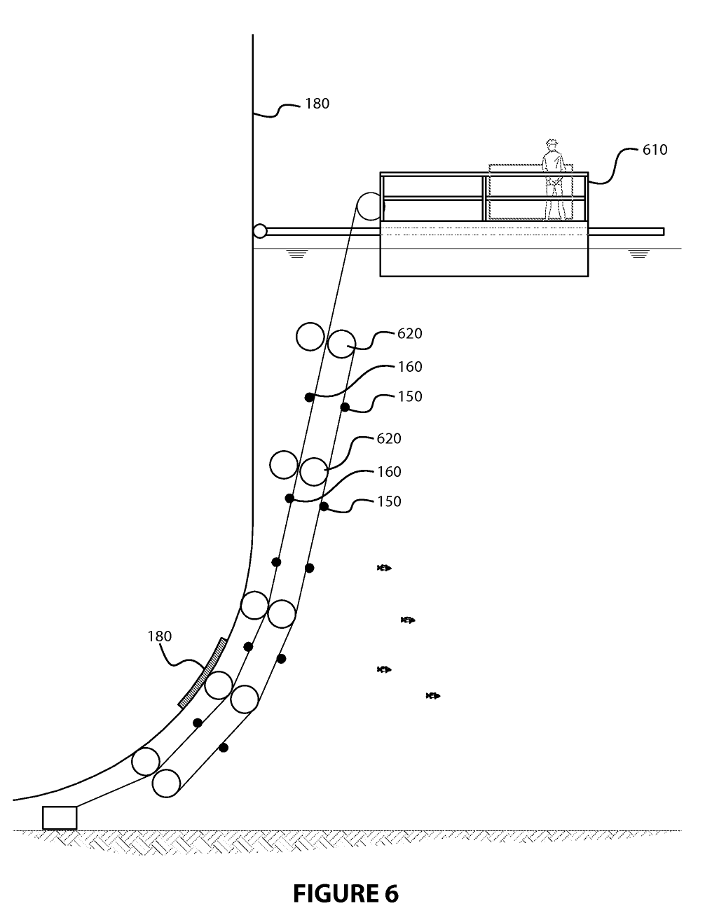

Now referring to FIG. 6 which is an embodiment of a fish entrainment system with a dual wrapped mat design that is positioned proximate to the hull 180 of the ship using a series of floats or ballasts 620. The ballasts 620 are affixed to the floor of the water body by an anchor 630 or alternatively attached to the hull 180. The ballasts are attached to a ballast support 640 which may be a rope, a cable, or similar support mechanism.

To create the electrical field between the anode and the cathode requires a pulsator. The pulsator should be capable of generating a constant current DC voltage, a pulsed DC voltage, or an AC voltage. Equipment that is capable of producing such a field is the Smith-Root® line of electrofishing equipment, including, but not limited to the: 1.5 kVA electrofisher system, the 2.5 GPP electrofisher system, the 5.0 GPP electrofisher system, the 7.5 GPP electrofisher system, the VVP-15B electrofisher system, and the type VI-A electrofisher system. These electrofishers would created a field between the anode and the cathode that is adjustable per the specifications of the equipment.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

I claim:

1. An apparatus for the entrainment of fish from seachests comprising:
a floatable platform on a body of water; said floatable platform having a top part and a bottom part, a front part, and a back part and an operating location on the top part of the floatable platform, the floatable platform being proximately placed relative to a hull of a ship;
an adjustable electrode system, the adjustable electrode system being vertically adjustable relative to the bottom part of the floatable platform and horizontally adjustable relative to the hull of the ship;
a pulsator, said pulsator being electrically connected to the adjustable electrode system;
so that when the pulsator is activated an electrical field is formed in the body of water proximate to the hull of the ship, fish are entrained from entering a seachest located in the hull of the ship.

2. The apparatus for the entrainment of fish from seachests as described in claim 1 wherein the adjustable electrode system further comprises a multiplicity of anodes and a multiplicity of cathodes, the electric field being induced in the water.

3. The apparatus for the entrainment of fish from seachests as described in claim 2 further comprising:
setting the pulsator to induce an electrical field between the anodes and the cathodes from 0.5 volts per inch to 1.5 volts per inch in the body of water proximate to the seachest located in the hull of the ship.

4. The apparatus for the entrainment of fish from seachests as described in claim 2 wherein the adjustable electrode system further comprises:
the multiplicity of cathodes vertically spaced in a vertically interleaved manner, and the multiplicity of anodes vertically spaced in a vertically interleaved manner,
so that the electrical fields may be positionally modified along the vertical axis.

5. The apparatus for the entrainment of fish from seachests as described in claim 2 further comprising:
setting the pulsator to induce an electrical field that is pulsed from a 1% to a 50% duty cycle.

6. The apparatus for the entrainment of fish as described in claim 2 wherein the adjustable electrode system further comprising:
a top part and a bottom part, the bottom part of the adjustable electrode system being mechanically connected to the hull of the ship.

7. An apparatus for the entrainment of fish from seachests comprising:
a hanging platform off the side of the ship above a body of water; said hanging platform having a top part and a bottom part, a front part, and a back part and an operating location on the top part of the hanging platform, the hanging platform being proximately alongside the hull of a ship;
an adjustable electrode system, the adjustable electrode system being vertically adjustable relative to the bottom part of the hanging platform and horizontally adjustable relative to the hull of the ship;
a pulsator, said pulsator being electrically connected to the adjustable electrode system and mechanically placed on the top part of the hanging platform;
so that when the pulsator is activated an electrical field is formed in the body of water proximate to the hull of the ship, fish are entrained from entering a seachest located in the hull of the ship.

8. The apparatus for the entrainment of fish from seachests as described in claim 7 wherein the adjustable electrode system further comprises a multiplicity of anodes and a multiplicity of cathodes, the electric field being induced in the water.

9. The apparatus for the entrainment of fish from seachests as described in claim 8 further comprising:
setting the pulsator to induce an electrical field between the anodes and the cathodes from 0.5 volts per inch to 1.5 volts per inch in the body of water proximate to the seachest located in the hull of the ship.

10. The apparatus for the entrainment of fish from seachests as described in claim 8 further comprising:
setting the pulsator to induce an electrical field that is pulsed from a 1% to a 50% duty cycle.

11. The apparatus for the entrainment of fish from seachests as described in claim 8 wherein the adjustable electrode system further comprises:
the multiplicity of cathodes vertically spaced in a vertically interleaved manner, and the multiplicity of anodes vertically spaced in a vertically interleaved manner,
so that the electrical fields may be positionally modified along the vertical axis.

12. A method for entrainment of fish proximate to seachests, comprising the steps of:
placing a multiplicity of anodes and cathodes relative to a seachest;
creating an electrical field between the anodes and cathodes; the electrical field created by a pulsator;
so that fish proximate to the anode and cathode are entrained by the electrical field.

13. The method for entrainment of fish proximate to seachests according the steps of claim 12 further comprising: comprising the steps of:
setting the pulsator to create a field ranging from 0.5 volts per inch to 1.5 volts per inch.

14. The method for entrainment of fish proximate to seachests according the steps of claim 12 further comprising: comprising the steps of:
setting the pulsator to create a field with a duty cycle from 1% to 50%.
